(19) United States
(12) Patent Application Publication
(10) Pub. No.: US 2026/0005568 A1
(43) Pub. Date: Jan. 1, 2026

(54) ACTUATOR COIL SUBSTRATE AND ACTUATOR

(71) Applicant: Mitsubishi Electric Corporation, Tokyo (JP)

(72) Inventors: Saku MORIMOTO, Tokyo (JP); Yuichiro NAKAMURA, Tokyo (JP); Jun HOSONO, Tokyo (JP); Yusuke SAKAMOTO, Tokyo (JP); Hideaki ARITA, Tokyo (JP)

(73) Assignee: Mitsubishi Electric Corporation, Tokyo (JP)

(21) Appl. No.: 18/879,895

(22) PCT Filed: Jul. 5, 2022
(86) PCT No.: PCT/JP2022/026661

§ 371 Date: Dec. 30, 2024

(51) Int. Cl. H02K 3/26; H02K 3/32; H02K 41/03

(52) U.S. Cl. CPC H02K 3/26; H02K 3/32; H02K 41/031

(57) ABSTRACT

An actuator coil substrate includes: a flexible insulating substrate wound around an axis; and a plurality of coils printed on the flexible insulating substrate, the coils being printed side by side in an axial direction. Each of the plurality of coils includes a conductor disposed in such a way as to extend in a circumferential direction of the axis. The flexible insulating substrate is wound in a cylindrical shape in a long side direction of each of the plurality of coils, or is wound such that a cross section orthogonal to the axis has a polygonal shape.

### FIELD

The present disclosure relates to an actuator coil substrate and an actuator.

### BACKGROUND

Actuators that make parallel motions are used for, for example, chip mounting in semiconductor manufacturing apparatuses. As one of the actuators, there is a shaft-type linear motor that includes a shaft-shaped magnet having a higher magnetic flux utilization rate than a flat plate-shaped magnet. Hereinafter, a shaft-type linear motor including a shaft-shaped magnet is referred to as a shaft-linear motor. An armature of a general shaft-linear motor includes a plurality of coils wound in a cylindrical shape. The coils are arranged at predetermined intervals by use of holding members or bobbins, and then ends of the coils are connected (see, for example, Patent Literature 1).

### CITATION LIST

### Patent Literature

Patent Literature 1: Japanese Patent Application Laid-open No. 2007-6637

### SUMMARY OF INVENTION

### Problem to be Solved by the Invention

Magnet wire is used as winding wire for the coil disclosed in Patent Literature 1. The magnet wire is wound in a cylindrical shape to form the coil. The shaft-linear motor is used for a head of a chip mounter or the like. Thus, coils of the shaft-linear motor are often small in size and diameter. Therefore, it is difficult to accurately wind the magnet wire in a cylindrical shape. Thus, winding collapse and a tangle of windings occur. Winding collapse and a tangle of windings cause coils to be enlarged. When a plurality of coils is arranged, a positional shift is likely to occur in an axial direction, and an electrical phase shift occurs in the same phase. As a result, thrust pulsation of an actuator increases. The invention according to claim 6 of Patent Literature 1 includes a winding member typified by a bobbin, which enables the invention to prevent positional shift in the axial direction to some extent. However, the above-described invention has a problem in that providing the winding member increases the number of parts, leading to an increase in manufacturing cost and enlargement of an entire armature. The enlargement of the entire armature affects enlargement of an entire shaft-linear motor.

The present disclosure has been made in view of the above, and an object of the present disclosure is to obtain an actuator coil substrate including a coil that can be formed while an increase in the size of an armature and an increase in the number of parts are prevented.

### Means to Solve the Problem

In order to solve the above-described problems and achieve the object, an actuator coil substrate according to the present disclosure includes: a flexible insulating substrate wound around an axis; and a plurality of coils printed on the flexible insulating substrate, the coils being printed side by side in an axial direction. Each of the plurality of coils includes a conductor disposed in such a way as to extend in a circumferential direction of the axis. The flexible insulating substrate is wound in a cylindrical shape in a long side direction of each of the plurality of coils, or is wound such that a cross section orthogonal to the axis has a polygonal shape.

### Effects of the Invention

The actuator coil substrate according to the present disclosure has an effect of being able to include a coil that can be formed while an increase in the size of an armature and an increase in the number of parts are prevented.

### BRIEF DESCRIPTION OF DRAWINGS

FIG. 1 is a perspective view of an actuator coil substrate according to a first embodiment.

FIG. 2 is a schematic diagram of the actuator coil substrate according to the first embodiment in a state where a flexible insulating substrate included in the actuator coil substrate has not been wound.

FIG. 3 is a schematic diagram of the actuator coil substrate according to the first embodiment in a state where the flexible insulating substrate included in the actuator coil substrate is being wound.

FIG. 4 is a perspective view of the actuator coil substrate according to the first embodiment.

FIG. 5 is a diagram schematically illustrating a cross section of the actuator coil substrate according to the first embodiment in which the flexible insulating substrate of FIG. 4 has been cut in one cross section.

FIG. 6 is a perspective view of an actuator coil substrate according to a second embodiment.

FIG. 7 is a schematic diagram of the actuator coil substrate according to the second embodiment in a state where a flexible insulating substrate included in the actuator coil substrate is being wound.

FIG. 8 is a cross-sectional view of the actuator coil substrate according to the second embodiment in which the flexible insulating substrate of FIG. 6 has been cut in one cross section.

FIG. 9 is a perspective view of an actuator coil substrate according to a third embodiment.

FIG. 10 is a schematic diagram of the actuator coil substrate according to the third embodiment in a state where a flexible insulating substrate included in the actuator coil substrate has not been wound.

FIG. 11 is a schematic diagram of an actuator coil substrate according to a fourth embodiment.

FIG. 12 is a schematic diagram of the actuator coil substrate according to the fourth embodiment.

FIG. 13 is a diagram illustrating an exemplary coil pattern that is not concentrated winding.

FIG. 14 is a diagram illustrating the exemplary coil pattern that is not concentrated winding.

FIG. 15 is a schematic diagram of an actuator coil substrate according to a fifth embodiment.

FIG. 16 is a schematic diagram of an actuator coil substrate according to a sixth embodiment.

FIG. 17 is a perspective view of an actuator according to a seventh embodiment.

FIG. 18 is a perspective view of the actuator according to the seventh embodiment.

FIG. 19 is a cross-sectional view of the actuator according to the seventh embodiment taken along one cross

FIG. 20 is a cross-sectional view of the actuator according to the seventh embodiment taken along another cross section.

FIG. 21 is a perspective view of an actuator according to an eighth embodiment.

FIG. 22 is a perspective view of the actuator according to the eighth embodiment.

FIG. 23 is a cross-sectional view of the actuator according to the eighth embodiment taken along one cross section.

FIG. 24 is a cross-sectional view of the actuator according to the eighth embodiment taken along another cross section.

FIG. 25 is a perspective view of an actuator according to a ninth embodiment.

FIG. 26 is a perspective view of the actuator according to the ninth embodiment.

FIG. 27 is a cross-sectional view of the actuator according to the ninth embodiment taken along one cross section. 20

FIG. 28 is a cross-sectional view of the actuator according to the ninth embodiment taken along another cross section.

FIG. 29 is a perspective view of an actuator according to a tenth embodiment.

FIG. 30 is a perspective view of the actuator according to the tenth embodiment.

FIG. 31 is a cross-sectional view of the actuator according to the tenth embodiment taken along one cross section. 30

FIG. 32 is a cross-sectional view of the actuator according to the tenth embodiment taken along another cross

FIG. 33 is a perspective view of an actuator according to an eleventh embodiment.

FIG. 34 is a perspective view of the actuator according to the eleventh embodiment.

FIG. 35 is a cross-sectional view of the actuator according to the eleventh embodiment taken along one cross section.

FIG. 36 is a cross-sectional view of the actuator according to the eleventh embodiment taken along another cross section.

### DESCRIPTION OF EMBODIMENTS

Hereinafter, actuator coil substrates and actuators according to embodiments will be described in detail with reference to the drawings.

### First Embodiment

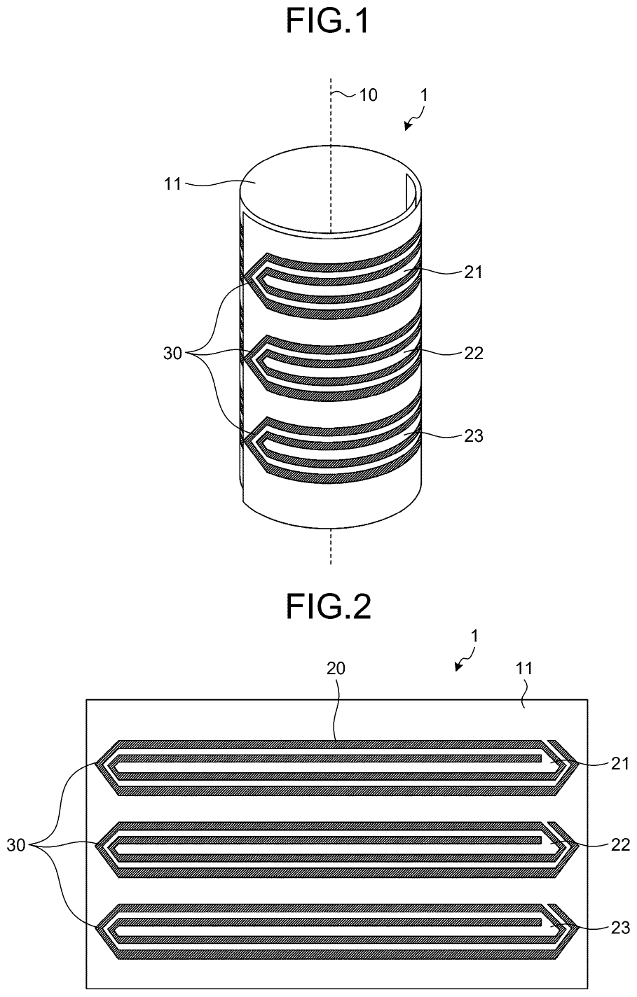

FIG. 1 is a perspective view of an actuator coil substrate 1 according to a first embodiment. FIG. 1 schematically illustrates the actuator coil substrate 1. The actuator coil substrate 1 includes a flexible insulating substrate 11 and three coils 21, 22, and 23. The flexible insulating substrate 11 is wound around an axis 10. The three coils 21, 22, and 23 are printed on the flexible insulating substrate 11. The axis 10 does not actually exist. The axis 10 is illustrated in FIG. 1 so as to describe the actuator coil substrate 1. The three coils 21, 22, and 23 are arranged side by side in an axial direction. The three coils 21, 22, and 23 exemplify a plurality of coils. Each of the three coils 21, 22, and 23 includes a conductor 30. Each conductor 30 is disposed such that a part of the conductor 30 extends in a direction in which the conductor 30 is wound around the axis 10. The direction in which the conductor 30 is wound around the axis 10 is a circumferential direction of a cylinder with the axis 10 as a central axis.

The shape of each of the three coils 21, 22, and 23 has a longitudinal direction and a lateral direction. Respective long sides of the conductors 30 of the three coils 21, 22, and 23 are wound around the axis 10. The conductor 30 extending in the longitudinal direction of each of the three coils 21, 22, and 23 is located in a plane perpendicular to the axis 10. The flexible insulating substrate 11 is wound in a cylindrical shape in a long side direction of each of the three coils 21, 22, and 23. Alternatively, the flexible insulating substrate 11 is wound such that a cross section orthogonal to the axis 10 has a polygonal shape. That is, the flexible insulating substrate 11 is wound around the axis 10 to form a cylindrical shape. Alternatively, the cross section of the flexible insulating substrate 11 perpendicular to the axis 10 has a substantially polygonal shape. In a cross section of the actuator coil substrate 1 perpendicular to the axis 10, the conductor 30 of each of the three coils 21, 22, and 23 may be spirally wound.

The three coils 21, 22, and 23 are disposed such that respective short sides of the conductors 30 are arranged in the axial direction, and the respective long sides of the conductors 30 are wound around the axis 10. Each of the three coils 21, 22, and 23 may be disposed in such a way as to be wound around the axis 10 by one or more turns. When viewed in a cross section perpendicular to the axis 10, the conductor 30 of each of the three coils 21, 22, and 23 may be penetrated multiple times by any half line radially extending from the axis 10, or may be penetrated multiple times by half lines radially extending from an entire circumference of the axis 10. A direction of a half line extending from the axis 10 in a cross section perpendicular to the axis 10 is referred to as a radial direction, and a direction of going around the axis 10 perpendicularly to the radial direction is referred to as a circumferential direction. The fact that the conductor 30 is penetrated multiple times by the above-described half line corresponds to the fact that the conductor 30 overlaps multiple times in the radial direction. The conductor 30 included in each of the three coils 21, 22, and 23 is disposed in such a way as to extend in the circumferential direction of the axis 10.

The longitudinally extending conductor 30 of each of the three coils 21, 22, and 23 may be disposed in a plane that is not perpendicular to the axis 10. In this case, when the flexible insulating substrate 11 is wound one or more turns, an extending portion of the conductor 30 has a spiral shape. The conductor 30 may be bent partway in the longitudinal direction to form a step-like portion, and be extended in the longitudinal direction. In this case, the wound conductor 30 is disposed in a plurality of planes with respect to the axis 10.

The flexible insulating substrate 11 having one surface on which the three coils 21, 22, and 23 have been printed are wound in a cylindrical shape to form the actuator coil substrate 1. FIG. 2 is a schematic diagram of the actuator coil substrate 1 according to the first embodiment in a state where the flexible insulating substrate 11 included in the actuator coil substrate 1 has not been wound. FIG. 2 also illustrates the three coils 21, 22, and 23 printed on the one surface of the flexible insulating substrate 11. The three coils 21, 22, and 23 are arranged in parallel. A longitudinal straight portion of the conductor 30 of each of the three coils 21, 22, and 23 turns back at an end and connected to another longitudinal straight portion of the same coil via a turnback portion.

When the conductor 30 of each of the three coils 21, 22, and 23 is traced in a single direction from one end to another end along the longitudinal direction, a first straight portion and a second straight portion are traced in opposite directions, the second straight portion being connected to the first straight portion via the turnback portion. When the flexible insulating substrate 11 is wound around the axis 10, a traveling direction for each of the first straight portion and the second straight portion corresponds to the circumferential direction. When current flows through the conductor 30 of each of the three coils 21, 22, and 23, the traveling direction for each of the first straight portion and the second straight portion corresponds to a direction in which the current flows.

Although the three coils 21, 22, and 23 are illustrated in FIG. 2, the number of coils to be printed on the flexible insulating substrate 11 may be set to any desired number. Each of the three coils 21, 22, and 23 has long side portions 20 in a direction perpendicular to a direction in which the three coils 21, 22, and 23 are arranged. That is, each of the three coils 21, 22, and 23 has the long side portions 20 in a direction corresponding to the circumferential direction. FIG. 2 illustrates the long side portions 20 extending linearly, but the long side portions 20 may be bent or curved partway.

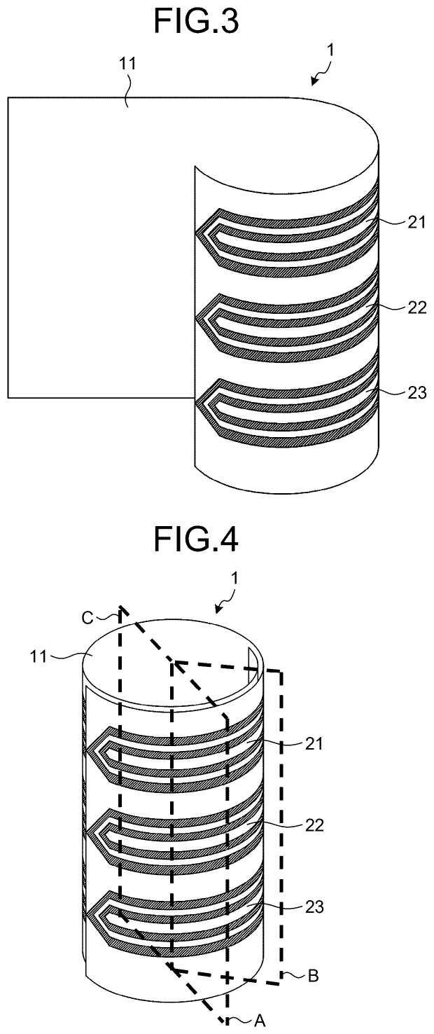

FIG. 3 is a schematic diagram of the actuator coil substrate 1 according to the first embodiment in a state where the flexible insulating substrate 11 included in the actuator coil substrate 1 is being wound. In FIG. 3, the flexible insulating substrate 11 is wound in the longitudinal direction of each of the three coils 21, 22, and 23. In FIG. 3, the flexible insulating substrate 11 is wound such that a coil printed surface faces outward. The coil printed surface is a surface on which the three coils 21, 22, and 23 have been printed, which is one of two surfaces of the flexible insulating substrate 11. The flexible insulating substrate 11 may be wound such that the coil printed surface faces inward. Depending on the radius of the cylindrical shape, the flexible insulating substrate 11 partly overlaps in the radial direction. However, since the flexible insulating substrate 11 has insulating performance, there is no possibility that a short circuit occurs even when the coil printed surface comes into contact with the other surface of the flexible insulating substrate 11, which is not the coil printed surface.

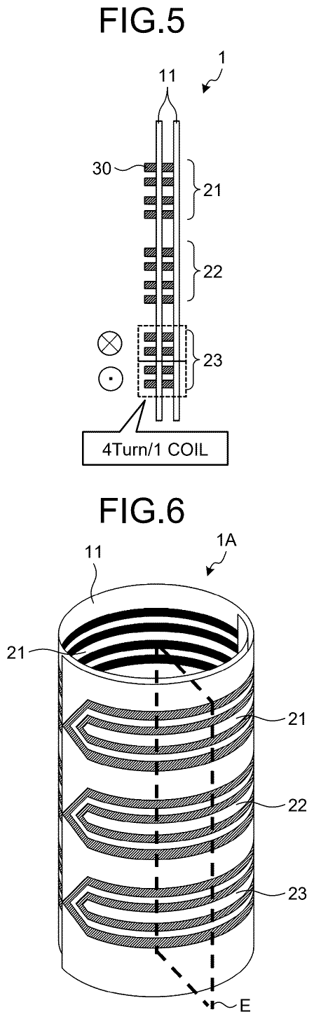

FIG. 4 is a perspective view of the actuator coil substrate 1 according to the first embodiment. FIG. 4 schematically illustrates the actuator coil substrate 1 illustrated in FIG. 1, and illustrates a cross section A, a cross section B, and a cross section C for describing the actuator coil substrate 1. FIG. 5 is a diagram schematically illustrating a cross section of the actuator coil substrate 1 according to the first embodiment in which the flexible insulating substrate 11 of FIG. 4 has been cut in the cross section A.

When the coils 21, 22, and 23 are printed on the flexible insulating substrate 11 as designed and the flexible insulating substrate 11 is wound without generating a gap, the conductors 30 included in the three coils 21, 22, and 23 are disposed at pitch distances determined by a print pattern in the axial direction of the cylindrical flexible insulating substrate 11 and disposed at an interval corresponding to a thickness of the flexible insulating substrate 11 in the radial direction of the cylindrical flexible insulating substrate 11. The number of turns of each of the three coils 21, 22, and 23 corresponds to the total number of conductors 30 aligned in the cross section orthogonal to the axis 10, which is the product of the number of turns of each of the three coils 21, 22, and 23 on the flexible insulating substrate 11 which has not been wound and the number of flexible insulating substrates 11 stacked in the radial direction. In FIG. 5, the number of turns of each of the three coils 21, 22, and 23 on the flexible insulating substrate 11 which has not been wound is two and the number of stacked flexible insulating substrates 11 is two. Therefore, the number of turns per coil is four. However, the number of turns may be set to any desired number.

Examples of possible causes of misalignment of aligned windings include an etching tolerance of the print pattern, a misalignment between the stacked layers of the wound flexible insulating substrate 11, and generation of a gap due to a winding bulge. Meanwhile, the misalignment of the windings is estimated to be less than 0.1 mm in any case. The amount of misalignment of the windings does not depend on cross-sectional dimensions of the windings. Meanwhile, the amount of misalignment due to winding collapse of the coil formed by magnet wire is estimated to be any integral multiple of a side length of the winding cross section, that is, one times the side length of the winding cross section, or twice or more the side length of the winding cross section. In the case of a circular cross section, the side length corresponds to a winding diameter. The finished outer diameter of a general winding is 0.1 mm or more. Therefore, the amount of winding misalignment in a coil structure of the first embodiment is smaller than the amount of misalignment to be generated in magnet-wire coils of almost all winding types.

Focusing on the amount of misalignment between the coils, only the etching tolerance of the print pattern contributes to the misalignment between the coils in the coil structure of the first embodiment. Thus, the amount of misalignment is estimated to be 0.01 mm or less. This is clearly smaller than the amount of misalignment to be caused after magnet wire is wound to form a coil. Furthermore, in the coil structure of the first embodiment, a holding member such as a bobbin is not necessary for positioning the coil. Thus, it is possible to prevent an increase in the number of parts and a decrease in winding space.

In the actuator coil substrate 1 according to the first embodiment, the rigidity of the flexible insulating substrate 11 does not change much anywhere in the circumferential direction. For example, cross-sectional shapes do not differ between the cross section A and the cross section B of FIG. 4 at all, and the flexible insulating substrate 11 is provided as a single layer in the cross section C. Therefore, rigidity at the cross section C is lower than rigidity at each of the cross sections A and B. However, as the number of turns of the flexible insulating substrate 11 increases, the difference between the rigidity of the flexible insulating substrate 11 at the cross sections A and B and the rigidity of the flexible insulating substrate 11 at the cross section C decreases.

As the number of turns of the flexible insulating substrate 11 increases in this manner, the rigidity of the flexible insulating substrate 11 approaches uniform rigidity in the circumferential direction. Therefore, when the number of turns of the flexible insulating substrate 11 increases, workability is good at the time of winding the flexible insulating substrate 11, and in addition, an axial end surface is less likely to be distorted after winding. As a result, it is possible to prevent the windings from locally approaching each other in the circumferential direction. Therefore, even when a gap between the conductors 30 is narrowed in the circumferential direction, insulating performance is maintained, and the conductor space factor of an actuator can be improved.

As described above, the actuator coil substrate 1 according to the first embodiment includes the flexible insulating substrate 11 and the three coils 21, 22, and 23. The flexible insulating substrate 11 is wound around the axis 10. The three coils 21, 22, and 23 are printed side by side in the axial direction on the flexible insulating substrate 11. Each of the three coils 21, 22, and 23 includes the conductor 30 disposed in such a way as to extend in the circumferential direction of the axis 10. The flexible insulating substrate 11 is wound in a cylindrical shape in the long side direction of each of the three coils 21, 22, and 23, or is wound such that the cross section orthogonal to the axis 10 has a polygonal shape.

Since the conductors 30 are printed on the flexible insulating substrate 11, a tangle of windings and misalignment between the coils become minute. As a result, the actuator coil substrate 1 according to the first embodiment can prevent enlargement of the coils and an increase in thrust pulsation. In addition, since the winding direction of the flexible insulating substrate 11 coincides with the long side direction of each coil, the rigidity of the flexible insulating substrate 11 becomes uniform in the winding direction. As a result, the actuator coil substrate 1 can achieve an effect of enabling the flexible insulating substrate 11 to be easily wound at the time of manufacturing.

The effect to be obtained by the actuator coil substrate 1 according to the first embodiment will be further described. The flexible insulating substrate 11 is easily deformed. Thus, the flexible insulating substrate 11 can be wound together with printed coils. An insulating material of the flexible insulating substrate 11 or a separate insulating layer is provided to ensure insulation of the coils. The interval between the conductors 30 of the coils wound in this manner is determined in the axial direction by the accuracy of printing made at the time of manufacturing the substrate, and is determined in the radial direction by the thickness of the flexible insulating substrate 11 or the thickness of the insulating layer. The above-described interval between the conductors 30 in the axial direction refers to the interval between the conductors 30 in a vertical direction of the cross section illustrated in FIG. 5. The above-described interval between the conductors 30 in the radial direction refers to the interval between the conductors 30 in a horizontal direction of the cross section illustrated in FIG. 5. The alignment property of the conductors 30 is generally very high as compared with a case where magnet wire is wound. Therefore, winding collapse of windings and a tangle of windings are less likely to occur in the actuator coil substrate 1. Thus, the actuator coil substrate 1 can prevent enlargement of the coil. The coils printed side by side in the axial direction are not displaced beyond the printing accuracy, so that an increase in thrust pulsation can be prevented. Furthermore, the actuator coil substrate 1 can include a coil that can be formed while an increase in the size of an armature and an increase in the number of parts are prevented.

### Second Embodiment

FIG. 6 is a perspective view of an actuator coil substrate 1A according to a second embodiment. FIG. 6 schematically illustrates the actuator coil substrate 1A. The actuator coil substrate 1A is different from the actuator coil substrate 1 according to the first embodiment in that coils are printed on both surfaces of the flexible insulating substrate 11. The coils printed on both surfaces of the flexible insulating substrate 11 are connected via vias. The number of turns in the actuator coil substrate 1A is twice the number of turns to be obtained in a case where coils are printed only on one of the surfaces of the flexible insulating substrate 11.

FIG. 6 illustrates the three coils 21, 22, and 23 printed on a front surface of the flexible insulating substrate 11 and the coil 21 printed on a back surface of the flexible insulating substrate 11. The front surface of the flexible insulating substrate 11 corresponds to an outer surface of the flexible insulating substrate 11 wound around the axis 10 to form a cylindrical shape. The back surface of the flexible insulating substrate 11 corresponds to an inner surface of the flexible insulating substrate 11 wound around the axis 10 to form the cylindrical shape. FIG. 6 also illustrates a cross section E for describing the actuator coil substrate 1A.

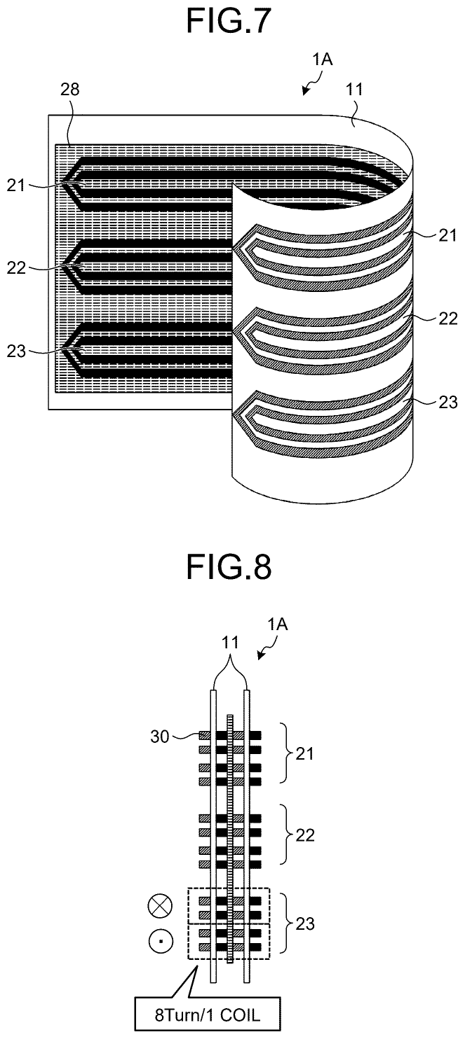

FIG. 7 is a schematic diagram of the actuator coil substrate 1A according to the second embodiment in a state where the flexible insulating substrate 11 included in the actuator coil substrate 1A is being wound. In the second embodiment, coils on one surface, that is, the coils on the back surface in FIG. 7, are coated with an insulating layer 28 for ensuring insulating performance. For example, coating of the coils with the insulating layer 28 is performed as follows: a solder resist is applied to a surface on which the coils have been printed, or an insulating sheet is attached to the surface on which the coils have been printed. Due to the coating of the coils on the one surface with the insulating layer 28, the coils on both surfaces are not short-circuited even when the flexible insulating substrate 11 is wound, as illustrated in FIG. 7, to bring the inner coils and the outer coils into contact with each other. The insulating layer 28 may be provided on both surfaces of the flexible insulating substrate 11.

FIG. 8 is a cross-sectional view of the actuator coil substrate 1A according to the second embodiment in which the flexible insulating substrate 11 of FIG. 6 has been cut in the cross section E. FIG. 8 schematically illustrates a cross section of the actuator coil substrate 1A. The number of coil turns to be obtained when the coils are arranged on both surfaces of the flexible insulating substrate 11 is twice the number of coil turns to be obtained when the coils are arranged only on one surface of the flexible insulating substrate 11. The number of turns is eight in the actuator coil substrate 1A according to the second embodiment illustrated in FIG. 6. Therefore, when coils having the same number of turns are formed, the length of the flexible insulating substrate 11 in the winding direction can be shortened to half in the actuator coil substrate 1A according to the second embodiment as compared with the case where coils are arranged only on one surface of the flexible insulating substrate 11. Thus, the longest dimension of the flexible insulating substrate 11 can be relaxed at the time of manufacturing the actuator coil substrate 1A.

### Third Embodiment

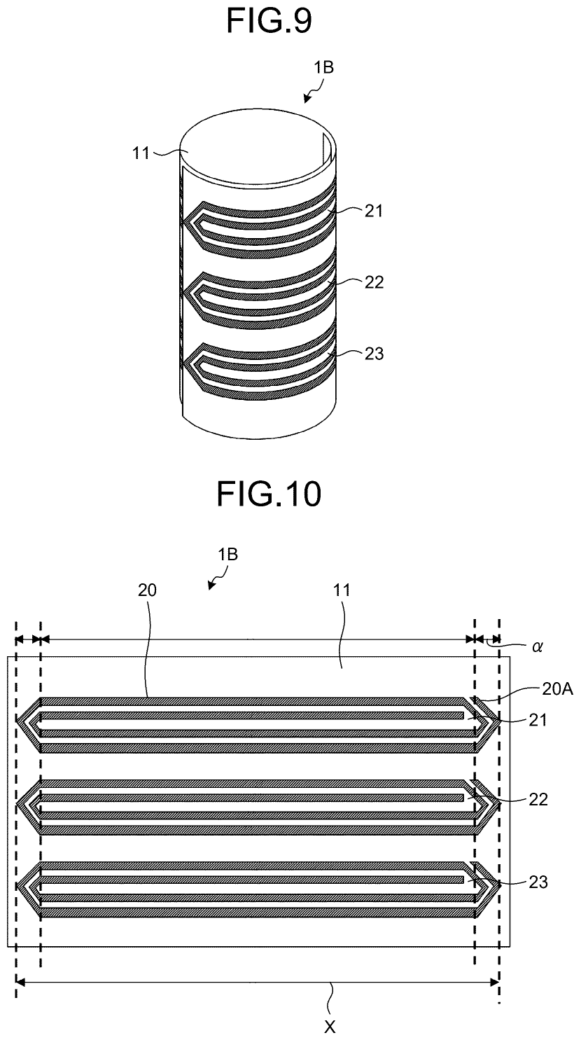

FIG. 9 is a perspective view of an actuator coil substrate 1B according to a third embodiment. FIG. 9 schematically illustrates the actuator coil substrate 1B. FIG. 10 is a schematic diagram of the actuator coil substrate 1B according to the third embodiment in a state where the flexible insulating substrate 11 included in the actuator coil substrate 1B has not been wound.

In the three coils 21, 22, and 23 included in the actuator coil substrate 1B, the long side portion 20 of each of the three coils 21, 22, and 23 generates thrust of an actuator in a traveling direction. A connecting wire portion 20A, which is at a coil end and connects the long side portion 20 and the long side portion 20 of the same phase in the axial direction, hardly contributes to the thrust of the actuator in the traveling direction. Hereinafter, the connecting wire portion 20A is referred to as a “coil end portion 20A”. That is, the thrust of the actuator in the traveling direction increases as the proportion of the long side portions 20 in the three coils 21, 22, and 23 facing a magnet becomes larger than the proportion of the coil end portions 20A therein.

In the third embodiment, the long-side directional length of the winding of each of the three coils 21, 22, and 23 formed on the flexible insulating substrate 11 is equal to or larger than the length of an inner circumference of the flexible insulating substrate 11 that has been cylindrically wound. That is, when the flexible insulating substrate 11 is wound, the long side portions 20 overlap at some portions in the radial direction. Therefore, it can be considered that the winding of a first turn and the winding of second and subsequent turns are connected in the circumferential direction for each of the three coils 21, 22, and 23. Thus, the proportion of the long side portions 20 can be increased.

For example, assume that X denotes coil length in the circumferential direction, and a denotes the length of the coil end portion 20A in a case where the longitudinal portion of each of the three coils 21, 22, and 23 is completed in one turn in the circumferential direction. Then, the ratio between the long side portion 20 and the coil end portion 20A of the coil is expressed by formula (1) below.

$$Long side portion 20 : coil end portion 20 A = X - 2 α : 2 α \qquad ( 1 )$$

Meanwhile, when the flexible insulating substrate 11 is wound n times in the circumferential direction, the ratio between the long side portion 20 and the coil end portion 20A is expressed by formula (2) below.

$$Long side portion 20 : coil end portion 20 A = nX - 2 α : 2 α = X - 2 α / n : 2 α / n \qquad ( 2 )$$

Since n>1 in the actuator coil substrate 1B illustrated in FIG. 9, the ratio between the long side portion 20 and the coil end portion 20A is expressed by formula (2). The ratio of formula (2) is larger than the ratio of formula (1). Therefore, in a coil structure of the third embodiment, thrust of the actuator in the traveling direction is larger than that to be obtained in a case where the longitudinal portion of each of the three coils 21, 22, and 23 is completed in one turn in the circumferential direction. In addition, as can be seen from formula (2), as the number of turns n of the flexible insulating substrate 11 increases, the proportion of the long side portions 20 increases and thus, the rate of increase in thrust also increases.

In the actuator coil substrate 1B according to the third embodiment, the length of the long side portion 20 in each of the three coils 21, 22, and 23 in the winding direction of the flexible insulating substrate 11 is larger than the length of the inner circumference of the cylinder formed by the flexible insulating substrate 11 that has been cylindrically wound. Since the long side portion 20 contributing to the thrust is wound one or more turns and the proportion of the long side portion 20 per coil length increases, the actuator coil substrate 1B contributes to an increase in the thrust of the actuator including the actuator coil substrate 1B.

### Fourth Embodiment

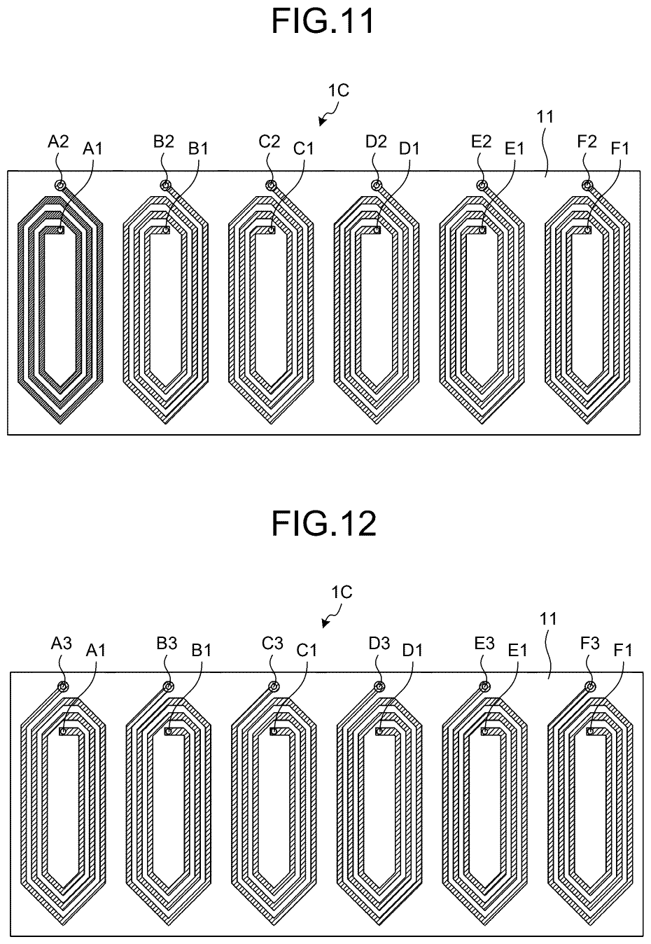

FIGS. 11 and 12 are both schematic diagrams of an actuator coil substrate 1C according to a fourth embodiment. In FIGS. 11 and 12, spiral objects are coils. FIGS. 11 and 12 illustrate the actuator coil substrate 1C in a state where the flexible insulating substrate 11 has not been wound. FIG. 11 illustrates a front surface of the flexible insulating substrate 11 of the actuator coil substrate 1C. FIG. 12 illustrates a back surface of the flexible insulating substrate 11 of the actuator coil substrate 1C, viewed through the front surface.

In the fourth embodiment, the flexible insulating substrate 11 is wound in the vertical direction, and coils are printed on both surfaces of the flexible insulating substrate 11. A coil pattern is formed such that respective axial center positions of windings coincide with each other. That is, the coils are so-called concentrated winding coils. Connection portions located beyond coil ends are omitted from FIGS. 11 and 12. Coils at the same position, in the axial direction, on the front and back surfaces of the flexible insulating substrate 11 are connected such that two terminals at the same position, that is, terminals A1, terminals B1, . . . , and terminals E1 are connected via inner vias or the like. The above-described axial direction corresponds to the horizontal direction in FIGS. 11 and 12.

Coils at different positions in the axial direction are connected in series or in parallel in such a way as to connect coils of the same phase in which currents are in phase. As an example, when two coils are connected in series by three-phase energization, a conceivable configuration is as follows: terminals A2, B2, and C2 serve as respective inflow sources of phase currents, terminal A3 is connected to terminal D2, terminal B3 is connected to terminal E2, terminal C3 is connected to terminal F2, and terminal D3, terminal E3, and terminal F3 are short-circuited.

Since the axial length of a shaft-linear motor is finite, the flexible insulating substrate 11 also has an end in the axial direction. In a case where the coils are concentrated winding coils as illustrated in FIGS. 11 and 12, it is possible to arrange the coils to both left and right ends of both surfaces of the flexible insulating substrate 11.

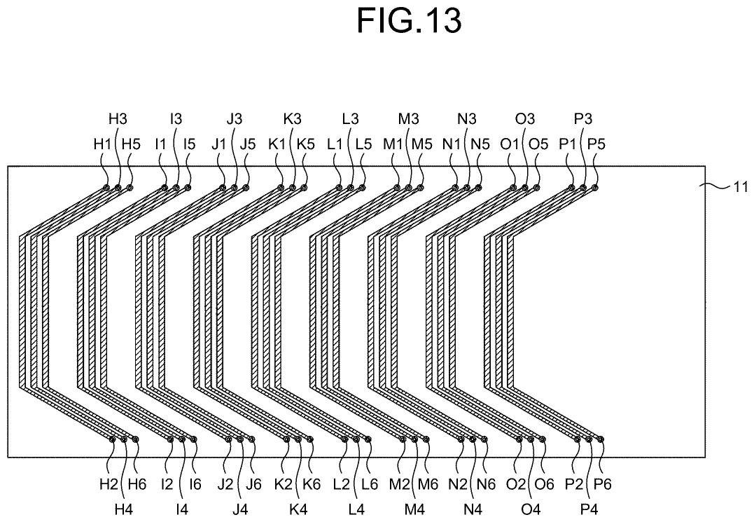

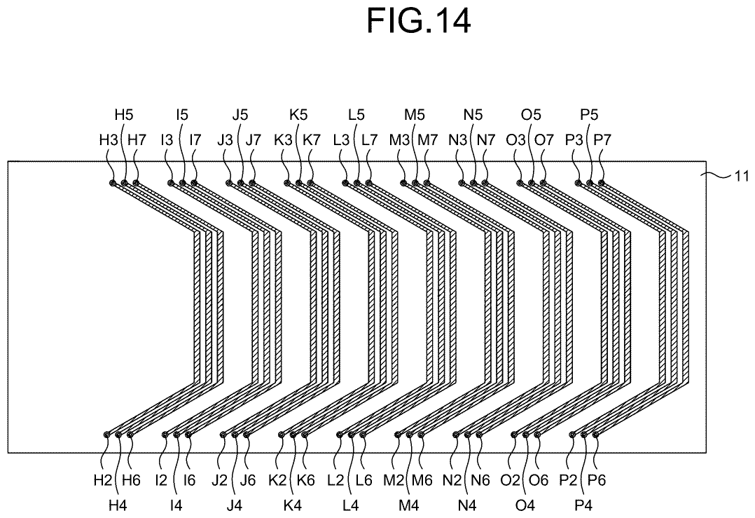

FIGS. 13 and 14 are diagrams for comparison with FIGS. 11 and 12, and are diagrams illustrating an exemplary coil pattern that is not concentrated winding. In FIGS. 13 and 14, spiral objects are coils. FIGS. 13 and 14 illustrate the actuator coil substrate in a state where the flexible insulating substrate 11 has not been wound. FIG. 13 illustrates the front surface of the flexible insulating substrate 11 of the actuator coil substrate. FIG. 14 illustrates the back surface of the flexible insulating substrate 11 of the actuator coil substrate, viewed through the front surface.

FIGS. 13 and 14 illustrate a state in which windings are arranged such that the windings are shifted at regular intervals in the axial direction. That is, FIGS. 13 and 14 illustrate so-called distributed winding. In FIGS. 13 and 14, each winding turn of the coils includes a portion formed on the front surface and a portion formed on the back surface of the flexible insulating substrate 11. Two terminals at the same position on both surfaces of the flexible insulating substrate 11, that is, terminals H2, . . . , terminals H6, terminals I2, . . . , terminals I6, . . . , terminals P2, . . . , and terminals P6 are connected via inner vias or the like to form three turns per coil while a loop of each winding is shifted in the axial direction.

Connection between the coils is made such that a long side portion on the front surface and a long side portion on the back surface of each coil are energized in the same phase and in the same direction. As an example, when three coils are connected in series by three-phase energization, a conceivable configuration is as follows: a terminal H1, a terminal I7, and a terminal J1 serve as respective inflow sources of phase currents, a terminal H7 is connected to a terminal K7, a terminal K1 is connected to a terminal N1, a terminal I1 is connected to a terminal L1, a terminal L7 is connected to a terminal O7, a terminal J7 is connected to a terminal M7, a terminal M1 is connected to a terminal P1, and a terminal N7, a terminal O1, and a terminal P7 are short-circuited.

In the case of the pattern illustrated in FIGS. 13 and 14, it is not possible to print long side portions on the right side of the front surface and the left side of the back surface with respect to the axial direction in relation to coil ends, or it is necessary to change the length of a long side portion or a coil end portion before printing. Both of the above lead to a decrease in the thrust of an actuator. Meanwhile, it can be said that the pattern of the fourth embodiment illustrated in FIGS. 11 and 12 contributes to improvement of the thrust of the actuator since the coils can be disposed up to the axial ends of both surfaces of the flexible insulating substrate 11.

In the actuator coil substrate 1C according to the fourth embodiment, each of the three coils 21, 22, and 23 is printed as a concentrated winding in which respective positions of winding turns in a single coil coincide with each other in the axial direction. Therefore, the coils 21, 22, and 23 can be disposed on both surfaces of the flexible insulating substrate 11 up to the axial ends. Thus, the number of turns of each of the three coils 21, 22, and 23 increases, and the thrust of the actuator including the actuator coil substrate 1C increases.

### Fifth Embodiment

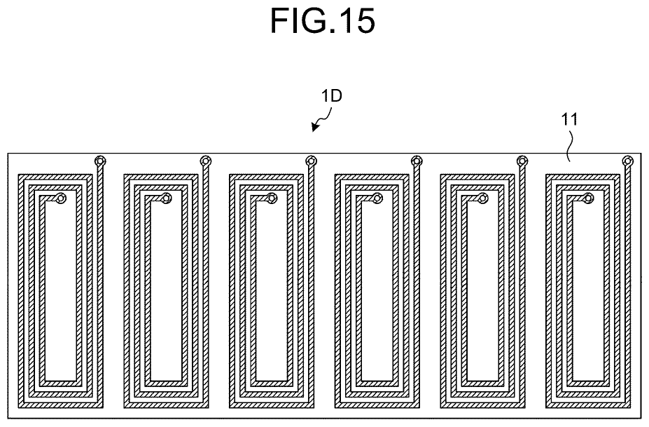

FIG. 15 is a schematic diagram of an actuator coil substrate 1D according to a fifth embodiment. In FIG. 15, spiral objects are coils. FIG. 15 illustrates a state in which windings are bent at 90 degrees at coil end portions of the coils printed as concentrated windings. That is, in each of a plurality of the coils, an end of a long side portion is bent at 90 degrees inside the flexible insulating substrate 11. As a result, it is possible to maximize the length of the long side portion that generates thrust per the same coil length. As a result, the thrust of an actuator including the actuator coil substrate 1D increases. In addition, according to the actuator coil substrate 1D, the length of the coil end portion is minimized in the winding direction. Therefore, it is also possible to obtain an advantage in that an area in which rigidity changes at the time of winding can be minimized. Furthermore, since windings, which are conductors, are densely distributed to the ends of the flexible insulating substrate 11, it is also possible to obtain an effect of easily winding the actuator coil substrate 1D.

### Sixth Embodiment

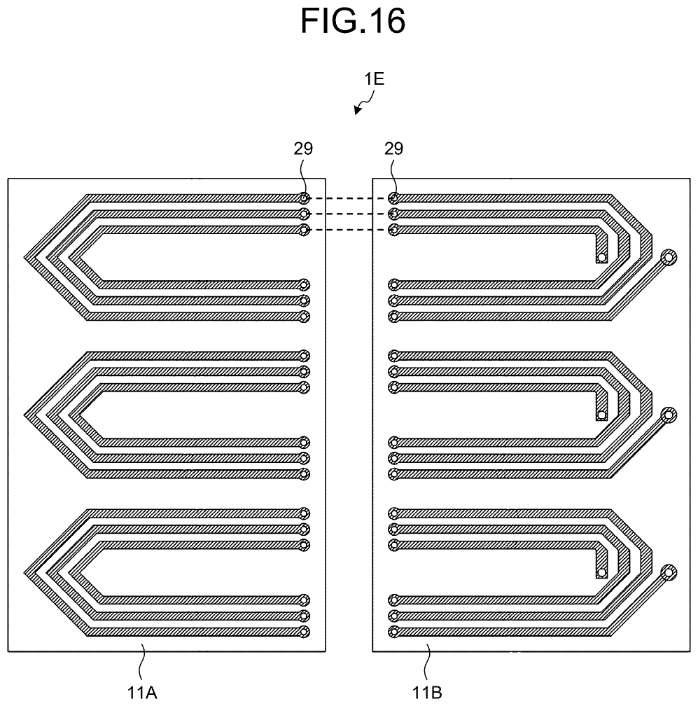

FIG. 16 is a schematic diagram of an actuator coil substrate 1E according to a sixth embodiment. FIG. 16 illustrates the actuator coil substrate 1E in a state where a substrate has not been wound, and illustrates front surfaces of different substrates 11A and 11B on the left side and the right side, respectively. In FIG. 16, spiral objects are coils. The substrates 11A and 11B are flexible insulating substrates. In FIG. 16, a direction in which the substrates 11A and 11B are wound corresponds to the horizontal direction. The coils printed on the substrates 11A and 11B are not established inside the left and right substrates 11A and 11B. Each coil is printed such that each coil is established when the left and right substrates 11A and 11B are connected in the winding direction. A terminal 29 is provided at an end of a winding to be connected on one of the substrates 11A and 11B, and is connected by a wire or the like to a terminal 29 at the same position, in the axial direction, on the other substrate. The axial direction corresponds to the vertical direction.

As described above, in the sixth embodiment, the flexible insulating substrate is divided in the winding direction. Coils printed on divided substrates are electrically connected to each other to establish electric connection between the divided substrates. That is, the actuator coil substrate 1E according to the sixth embodiment can eliminate manufacturing limitation on substrate length in the winding direction, and can be used in a case where the number of turns of the flexible insulating substrate is very large or a case where the winding diameter is very large.

Note that although the two left and right substrates 11A and 11B are illustrated in FIG. 16, three or more substrates may be connected. In such a case, a coil end portion is included in a substrate at the left end and in a substrate at the right end. With this substrate configuration, there is no manufacturing limitation on substrate length in the winding direction of the substrate. Thus, this configuration can be applied to a case where the number of turns of the substrate is very large or a case where the winding diameter is very large.

### Seventh Embodiment

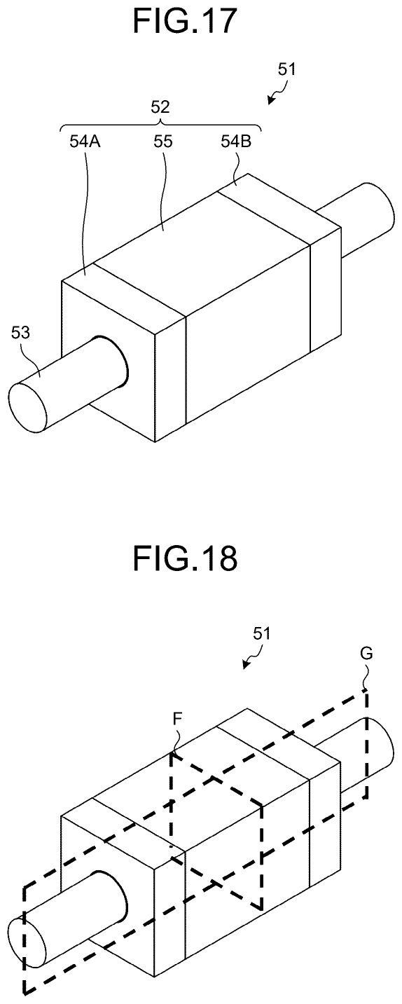

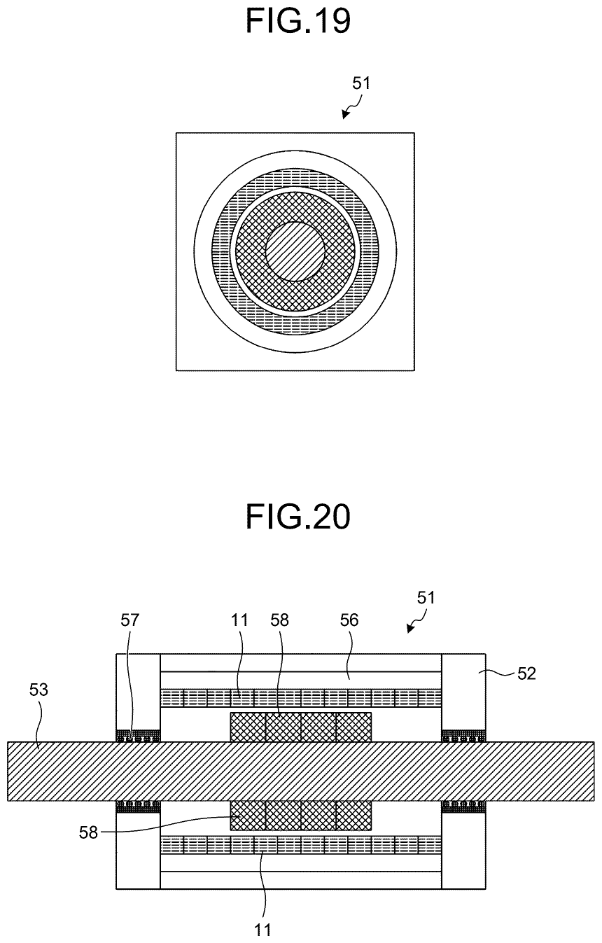

FIGS. 17 and 18 are perspective views of an actuator 51 according to a seventh embodiment. FIGS. 17 and 18 schematically illustrate the actuator 51. FIG. 18 illustrates a cross section F and a cross section G for describing the actuator 51. FIG. 19 is a cross-sectional view of the actuator 51 according to the seventh embodiment taken along the cross section F. FIG. 20 is a cross-sectional view of the actuator 51 according to the seventh embodiment taken along the cross section G. FIGS. 19 and 20 schematically illustrate the cross sections of the actuator 51.

The actuator 51 includes a housing 52 and a shaft 53. The housing 52 has a rectangular parallelepiped outer shape. The shaft 53 has a cylindrical shape, and protrudes from the housing 52. The outer side of the housing 52 is covered with brackets 54A and 54B and a frame 55. The inner surface of the frame 55 has a cylindrical shape. A core 56 of a soft magnetic material is inserted in the frame 55, along the inner peripheral surface of the frame 55. An actuator coil substrate including the flexible insulating substrate 11 wound in a cylindrical shape is inserted in the core 56.

Bearings 57 that reduce axial sliding resistance are installed at radial central portions of the brackets 54A and 54B such that the shaft 53 is held by the bearings 57 of the brackets 54A and 54B on both sides. A magnet 58 is attached to a surface of a part of the shaft 53, the part being located inside the housing 52. The magnet 58 is located at a certain distance from the flexible insulating substrate 11 in such a way as to face the flexible insulating substrate 11. The magnet 58 is magnetized in the radial direction, and magnetization orientation is switched at regular intervals in the axial direction. FIG. 20 illustrates the magnet 58, which is a four-pole magnet, and twelve flexible insulating substrates 11. Meanwhile, the number of poles of the magnet 58, the number of flexible insulating substrates 11, and arrangement of the magnet 58 and the flexible insulating substrates 11 are not limited to those illustrated in FIG. 20.

When a current with constant periodicity is applied to the flexible insulating substrate 11, the flexible insulating substrate 11 serves as an armature, and causes the housing 52 or the shaft 53 to be in translational motion in the axial direction. Therefore, it is possible to move only one of the housing 52 and the shaft 53 by fixing the other so as not to move. Compared with the conventional shaft-linear motor, the structure of the actuator 51 according to the seventh embodiment illustrated in FIG. 17 is simplified, where a small number of holding members are provided around the armature. Thus, space occupied by the armature in the housing 52 increases, so that the thrust of the actuator 51 increases.

### Eighth Embodiment

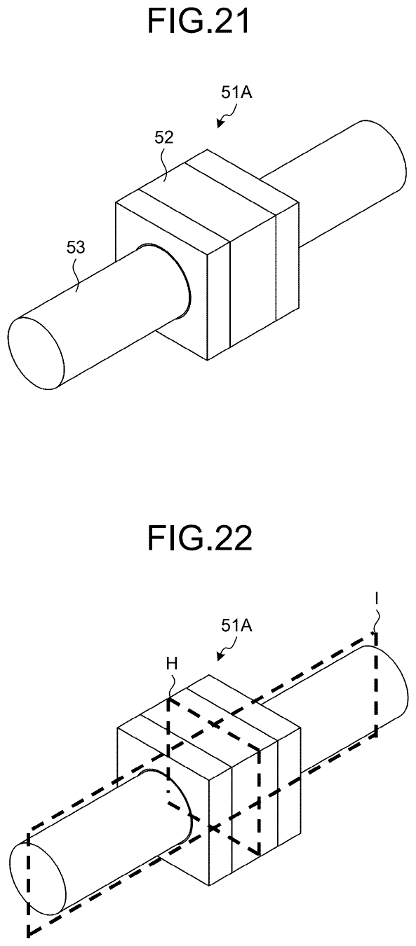

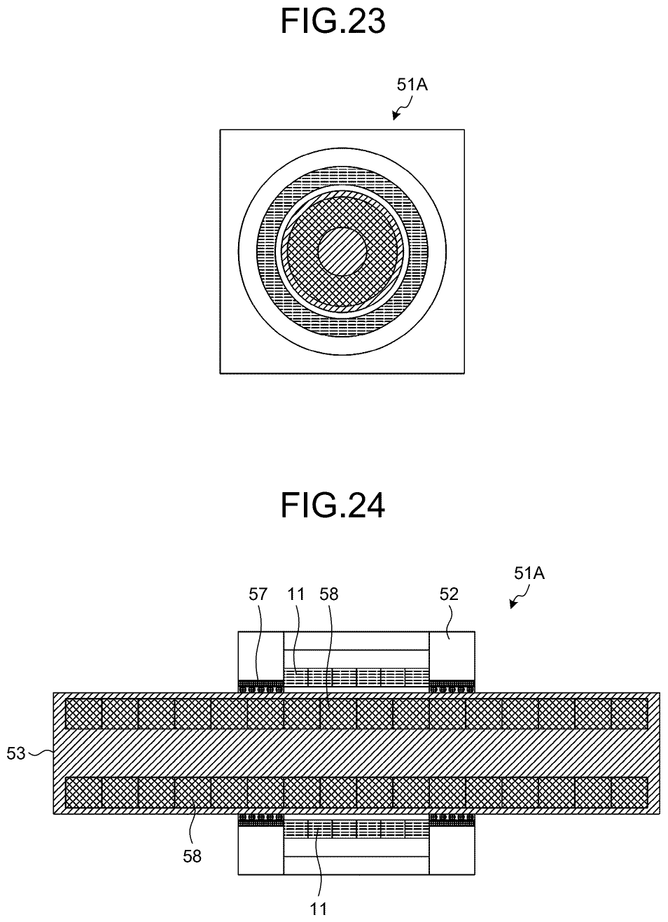

FIGS. 21 and 22 are perspective views of an actuator 51A according to an eighth embodiment. FIGS. 21 and 22 schematically illustrate the actuator 51A. FIG. 22 illustrates a cross section H and a cross section I for describing the actuator 51A. FIG. 23 is a cross-sectional view of the actuator 51A according to the eighth embodiment taken along the cross section H. FIG. 24 is a cross-sectional view of the actuator 51A according to the eighth embodiment taken along the cross section I. FIGS. 23 and 24 schematically illustrate the cross sections of the actuator 51A.

As compared with the actuator 51 according to the seventh embodiment illustrated in FIG. 17, the magnet 58 is not attached to the surface of the shaft 53 but is located inside the shaft 53 in the actuator 51A according to the eighth embodiment illustrated in FIG. 21. A method of inserting the magnet 58 in a cylindrical shape into the shaft 53 in a cylindrical shape or molding the shaft 53 such that the shaft 53 includes the magnet 58 is a conceivable method for manufacturing the shaft 53. In the actuator 51A, the diameter of the shaft 53 is constant over the entire shaft 53. Thus, the movable range of the shaft 53 can be widened in the axial direction. Since it is not necessary to ensure a space for avoiding contact with the magnet 58 in the housing 52, the actuator 51A allows the housing 52 to be shortened in the axial direction.

### Ninth Embodiment

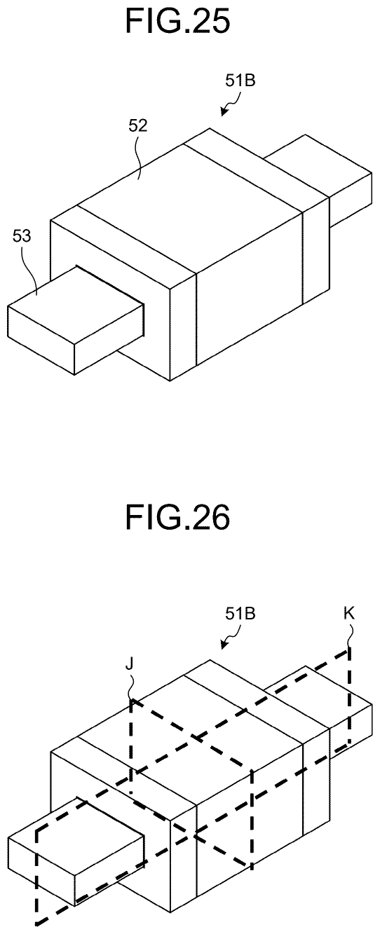

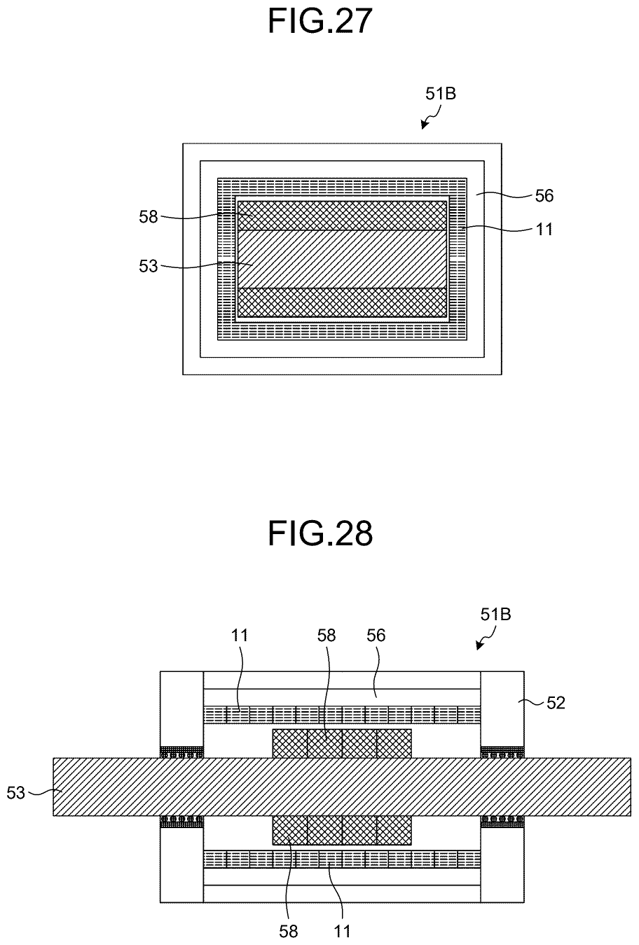

FIGS. 25 and 26 are perspective views of an actuator 51B according to a ninth embodiment. FIGS. 25 and 26 schematically illustrate the actuator 51B. FIG. 26 illustrates a cross section J and a cross section K for describing the actuator 51B. FIG. 27 is a cross-sectional view of the actuator 51B according to the ninth embodiment taken along the cross section J. FIG. 28 is a cross-sectional view of the actuator 51B according to the ninth embodiment taken along the cross section K. FIGS. 27 and 28 schematically illustrate the cross sections of the actuator 51B.

As compared with the actuator 51 according to the seventh embodiment illustrated in FIG. 17, cross sections of the housing 52 and the shaft 53 are rectangular with long sides facing the magnet 58 in the actuator 51B according to the ninth embodiment illustrated in FIG. 25. Axial cross sections of the core 56 and the flexible insulating substrate 11 located inside the housing 52 are rectangular in accordance with the shape of the housing 52. The magnets 58 that are plate-shaped or block-shaped magnets are attached to upper and lower surfaces of the shaft 53 in such a way as to face the flexible insulating substrate 11 with a large area. Magnetization orientations of the magnets 58 are opposite to each other in the radial direction on the upper and lower surfaces of the shaft 53, and upper and lower directions of the magnetization orientations are switched at regular intervals in the axial direction.

In FIG. 25, no magnet is attached to side surfaces of the shaft 53, but a structure in which an additional magnet is attached to one side surface or both side surfaces of the shaft 53 to increase surfaces of magnets facing the coil is also a conceivable structure.

In the structure of the ninth embodiment, the actuator 51B has a rectangular cross section, so that the actuator 51B can be installed in a narrow space. Since the magnet 58 in a rectangular shape is used, the magnet 58 is easily processed, and manufacturing cost of the actuator 51B is reduced.

### Tenth Embodiment

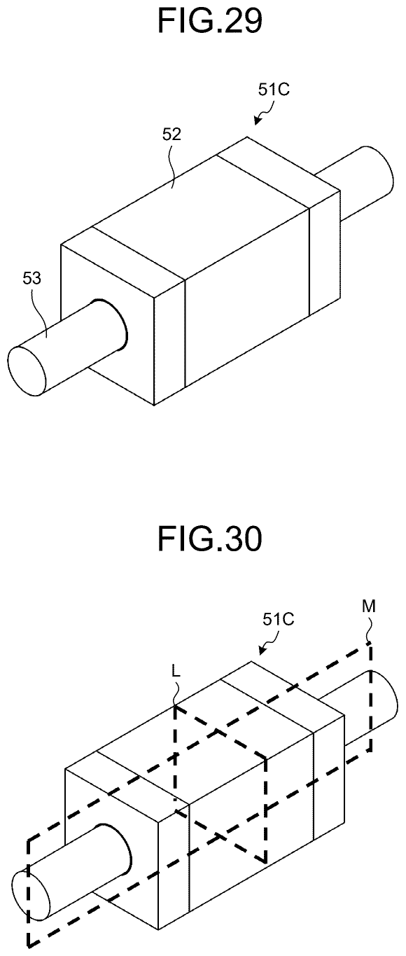

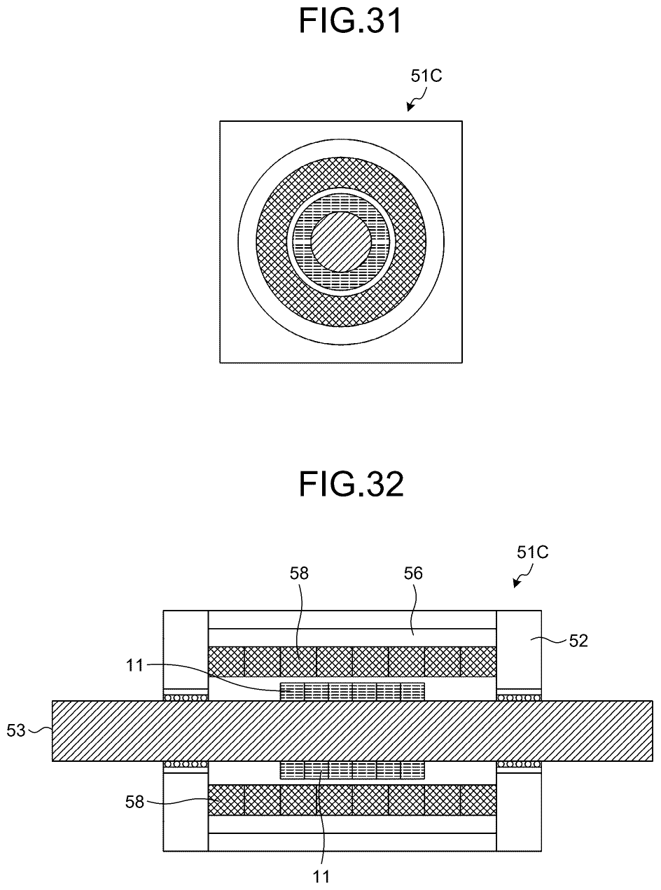

FIGS. 29 and 30 are perspective views of an actuator 51C according to a tenth embodiment. FIGS. 29 and 30 schematically illustrate the actuator 51C. FIG. 30 illustrates a cross section L and a cross section M for describing the actuator 51C. FIG. 31 is a cross-sectional view of the actuator 51C according to the tenth embodiment taken along the cross section L. FIG. 32 is a cross-sectional view of the actuator 51C according to the tenth embodiment taken along the cross section M. FIGS. 31 and 32 schematically illustrate the cross sections of the actuator 51C.

As compared with the actuator 51 according to the seventh embodiment illustrated in FIG. 17, attachment positions of the flexible insulating substrate 11 and the magnet 58 are reversed in the actuator 51C according to the tenth embodiment illustrated in FIG. 29. The magnet 58 is attached inside the core 56 of the housing 52, and the flexible insulating substrate 11 is wound around the surface of the shaft 53.

When the housing 52 is manufactured for the actuator 51 according to the seventh embodiment, in which the flexible insulating substrate 11 is installed to the housing 52, a conceivable manufacturing process is as follows: the flexible insulating substrate 11 is wound around a jig serving as a cylindrical mandrel, the jig is removed after adhesion, and the flexible insulating substrate 11 is attached to the core 56. In the structure of the actuator 51C according to the tenth embodiment, the flexible insulating substrate 11 can be directly wound around the shaft 53 by use of the shaft 53 as a mandrel. Thus, the manufacturing process is simplified. In the structure of the actuator 51C, it is not necessary to remove the jig. Therefore, there is no risk that the inner peripheral surface of the flexible insulating substrate 11 may be damaged by the sliding of the jig.

### Eleventh Embodiment

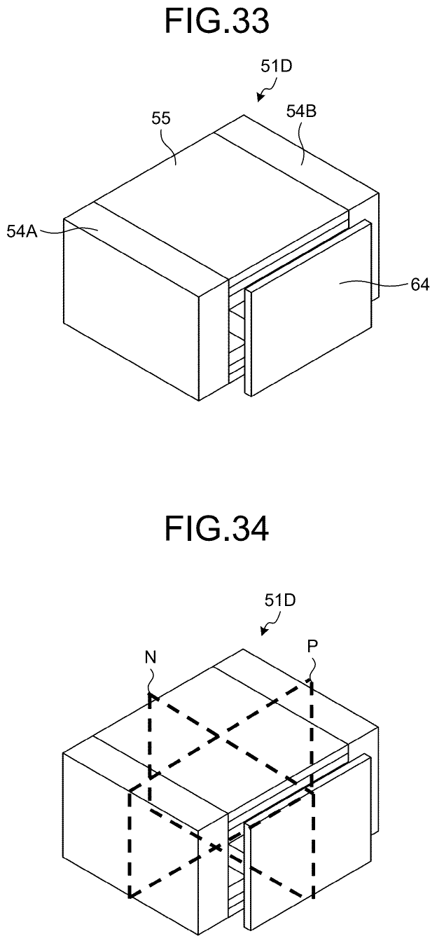

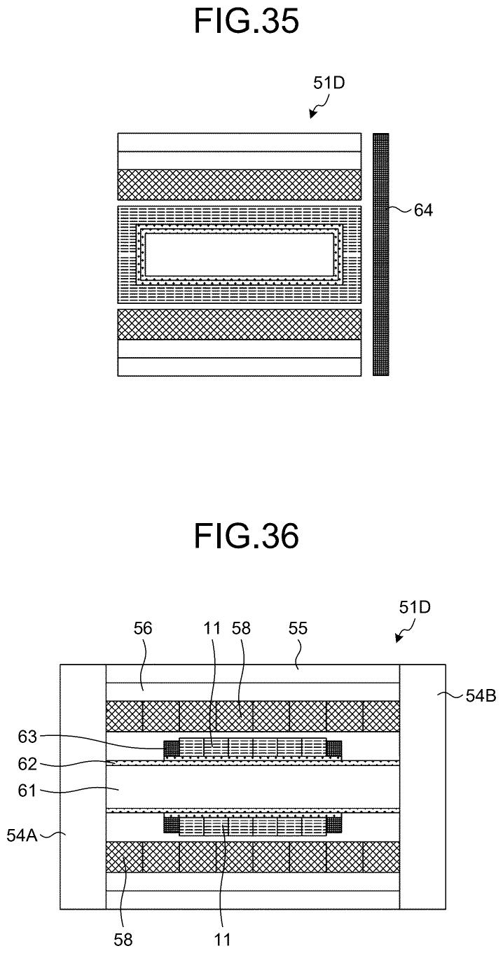

FIGS. 33 and 34 are perspective views of an actuator 51D according to an eleventh embodiment. FIGS. 33 and 34 schematically illustrate the actuator 51D. FIG. 34 illustrates a cross section N and a cross section P for describing the actuator 51D. FIG. 35 is a cross-sectional view of the actuator 51D according to the eleventh embodiment taken along the cross section N. FIG. 36 is a cross-sectional view of the actuator 51D according to the eleventh embodiment taken along the cross section P. FIGS. 35 and 36 schematically illustrate the cross sections of the actuator 51D.

The actuator 51D according to the eleventh embodiment illustrated in FIG. 33 does not include the shaft 53 included in the actuators 51, 51A, 51B, and 51C. The actuator 51D includes a support iron core 61 disposed at the center of the housing 52, instead of the shaft 53. The support iron core 61 is connected to the brackets 54A and 54B. The cross-sectional shape of the support iron core 61 is rectangular. A sliding part 62 is attached to each surface of the support iron core 61, and the flexible insulating substrate 11 is wound around the outside of the sliding part 62. As a result, the flexible insulating substrate 11 can move in parallel around the support iron core 61. Support rods 63 extend from portions of the sliding part 62 around which the flexible insulating substrate 11 is not wound. The support rods 63 support a table 64 located outside the housing 52. Thus, the parallel movement of the flexible insulating substrate 11 is transmitted to the table 64 via the sliding part 62.

The cores 56 are disposed inside the frames 55 of the housing 52. The magnets 58 are attached to the insides of the cores 56, and face the front surface and the back surface of the flexible insulating substrate 11. In FIG. 33, the table 64 is attached to the support rods 63 extending from one side surface of the housing 52. Meanwhile, it is also conceivable that surfaces of the magnets 58 facing the coil are increased by, for example, the following structure: the support rods 63 are extended from both sides of the housing 52, or the magnet 58 is also attached to a side surface facing the one side surface of the housing 52. When an armature serves as a mover in the actuator 51D according to the eleventh embodiment, the weight of the mover excluding the table 64 can be reduced as much as possible. As a result, a high thrust density can be obtained.

Each of the actuators 51, 51A, 51B, 51C, and 51D according to the seventh to eleventh embodiments includes an actuator coil substrate and the magnet 58 disposed in such a way as to face the actuator coil substrate. The actuator coil substrate is the actuator coil substrate according to any one of the first to sixth embodiments. The structure of each of the actuators 51, 51A, 51B, 51C, and 51D according to the seventh to eleventh embodiments is simplified, where a small number of holding members are provided around coils. Thus, space occupied by the armature in the housing 52 increases. As a result, the thrust of the actuators 51, 51A, 51B, 51C, and 51D increases.

In the actuators 51, 51A, and 51B according to the seventh to ninth embodiments, a mover or a stator including the magnet 58 is disposed in each of a plurality of coils. As compared with a configuration in which a magnet is disposed outside a coil, the outer diameter or volume of the magnet can be reduced in the actuators 51, 51A, and 51B. Thus, it is possible to reduce the amount of rare earth to be used and manufacturing cost.

In the actuators 51C and 51D of the tenth and eleventh embodiments, a mover or a stator including a magnet is disposed outside each of a plurality of coils. In the actuators 51C and 51D, the flexible insulating substrate 11 can be directly wound by use of the shaft 53 or the sliding part 62 as a mandrel. As a result, the manufacturing process is simplified. In addition, since it is not necessary to remove the jig, there is no risk that the inner peripheral surface of the flexible insulating substrate 11 may be damaged by the sliding of the jig, and a clearance for removing the jig is not necessary. Therefore, it is possible to wind the flexible insulating substrate 11 at a higher density, so that the actuators 51C and 51D contribute to improvement in the thrust of the motor.

The configurations set forth in the above embodiments show examples, and it is possible to combine the configurations with another known technique or combine the embodiments with each other, and is also possible to partially omit or change the configurations without departing from the gist of the present disclosure.

### REFERENCE SIGNS LIST

1, 1A, 1B, 1C, 1D, 1E actuator coil substrate; 10 axis; 11 flexible insulating substrate; 11A, 11B substrate; 20 long side portion; 20A coil end portion; 21, 22, 23 coil; 28 insulating layer; 29 terminal; 30 conductor; 51, 51A, 51B, 51C, 51D actuator; 52 housing; 53 shaft; 54A, 54B bracket; 55 frame; 56 core; 57 5 bearing; 58 magnet; 61 support iron core; 62 sliding part; 63 support rod; 64 table.

1. An actuator coil substrate comprising:
a flexible insulating substrate wound around an axis; and
a plurality of coils printed on the flexible insulating substrate, the coils being printed side by side in an axial direction, wherein
each of the plurality of coils includes a conductor disposed in such a way as to extend in a circumferential direction of the axis,
when the conductor of each of the coils is traced in a single direction from one end to another end along a longitudinal direction, a first straight portion and a second straight portion are traced in opposite directions, the second straight portion being connected to the first straight portion via a turnback portion,
the plurality of coils is connected in series or in parallel such that currents flowing through the conductors of the connected coils are in phase,
the flexible insulating substrate is wound in a cylindrical shape in a long side direction of each of the plurality of coils, or is wound such that a cross section orthogonal to the axis has a polygonal shape, and
the coils are printed on both surfaces of the flexible insulating substrate, and only coils on one surface are coated with an insulating layer, or an insulating sheet is attached only to the one surface.

2. The actuator coil substrate according to claim 1, wherein
a length of a long side portion of each of the plurality of coils in a winding direction of the flexible insulating substrate is larger than a length of an inner circumference of a cylinder formed by the flexible insulating substrate that has been cylindrically wound.

3. The actuator coil substrate according to claim 1, wherein
each of the plurality of coils is printed as a concentrated winding in which respective positions of winding turns in a single coil coincide with each other in the axial direction.

4. The actuator coil substrate according to claim 3, wherein
an end of a long side portion of each of the plurality of coils is bent at an angle of 90 degrees inside the flexible insulating substrate.

5. The actuator coil substrate according to claim 1, wherein
the flexible insulating substrate is divided in a winding direction, and
coils printed on divided substrates are electrically connected to each other to establish electric connection between the divided substrates.

6. An actuator comprising:
the actuator coil substrate according to claim 1; and
a magnet disposed in such a way as to face the actuator coil substrate.

7.-8. (canceled)

9. An actuator coil substrate comprising:
a flexible insulating substrate wound around an axis; and
a plurality of coils printed on the flexible insulating substrate, the coils being printed side by side in an axial direction, wherein
each of the plurality of coils includes a conductor disposed in such a way as to extend in a circumferential direction of the axis,
when the conductor of each of the coils is traced in a single direction from one end to another end along a longitudinal direction, a first straight portion and a second straight portion are traced in opposite directions, the second straight portion being connected to the first straight portion via a turnback portion,
the plurality of coils is connected in series or in parallel such that currents flowing through the conductors of the connected coils are in phase,
the flexible insulating substrate is divided in a winding direction, and no coil is established on each of divided substrates, and
coils printed on the divided substrates are electrically connected to each other to establish electric connection between the divided substrates so that coils are formed by the electric connection between the divided substrates.

10. The actuator coil substrate according to claim 9, wherein
a length of a long side portion of each of the plurality of coils in a winding direction of the flexible insulating substrate is larger than a length of an inner circumference of a cylinder formed by the flexible insulating substrate that has been cylindrically wound.

11. The actuator coil substrate according to claim 9, wherein
each of the plurality of coils is printed as a concentrated winding in which respective positions of winding turns in a single coil coincide with each other in the axial direction.

12. The actuator coil substrate according to claim 11, wherein
an end of a long side portion of each of the plurality of coils is bent at an angle of 90 degrees inside the flexible insulating substrate.

13. The actuator coil substrate according to claim 9, wherein
the flexible insulating substrate is divided in a winding direction, and
coils printed on divided substrates are electrically connected to each other to establish electric connection between the divided substrates.

14. An actuator comprising:
the actuator coil substrate according to claim 9; and
a magnet disposed in such a way as to face the actuator coil substrate.

15. An actuator coil substrate comprising:
a flexible insulating substrate wound around an axis; and
a plurality of coils printed on the flexible insulating substrate, the coils being printed side by side in an axial direction, wherein
each of the plurality of coils includes a conductor disposed in such a way as to extend in a circumferential direction of the axis,
when the conductor of each of the coils is traced in a single direction from one end to another end along a longitudinal direction, a first straight portion and a second straight portion are traced in opposite directions, the second straight portion being connected to the first straight portion via a turnback portion,
the plurality of coils is connected in series or in parallel such that currents flowing through the conductors of the connected coils are in phase,
the flexible insulating substrate is wound in a cylindrical shape in a long side direction of each of the plurality of coils, or is wound such that a cross section orthogonal to the axis has a polygonal shape, and
the coils are printed on both surfaces of the flexible insulating substrate,
an insulating layer is disposed between a first portion of the conductor printed on an inner surface of the wound flexible insulating substrate and a second portion of the conductor printed on an outer surface of the wound flexible insulating substrate, the second portion being located inside the first portion.

16. The actuator coil substrate according to claim 15, wherein
conductors separately printed on a front surface and a back surface of the flexible insulating substrate are connected via an inner via to form each winding turn of each of the coils, and respective loops of windings are shifted in the axial direction such that each of the coils forms a distributed winding.

17. The actuator coil substrate according to claim 15, wherein
a length of a long side portion of each of the plurality of coils in a winding direction of the flexible insulating substrate is larger than a length of an inner circumference of a cylinder formed by the flexible insulating substrate that has been cylindrically wound.

18. The actuator coil substrate according to claim 15, wherein
each of the plurality of coils is printed as a concentrated winding in which respective positions of winding turns in a single coil coincide with each other in the axial direction.

19. The actuator coil substrate according to claim 18, wherein
an end of a long side portion of each of the plurality of coils is bent at an angle of 90 degrees inside the flexible insulating substrate.

20. The actuator coil substrate according to claim 15, wherein
the flexible insulating substrate is divided in a winding direction, and
coils printed on divided substrates are electrically connected to each other to establish electric connection between the divided substrates.

21. An actuator comprising:
the actuator coil substrate according to claim 15; and
a magnet disposed in such a way as to face the actuator coil substrate.

22. An actuator comprising:
the actuator coil substrate according to claim 16; and
a magnet disposed in such a way as to face the actuator coil substrate.
